(19) United States
(12) Patent Application Publication
(10) Pub. No.: US 2015/0026696 A1
(43) Pub. Date: Jan. 22, 2015

(54) SYSTEMS AND METHODS FOR SCHEDULING VEHICLE-RELATED TASKS

(71) Applicant: GENERAL ELECTRIC COMPANY, Schenectady, NY (US)

(72) Inventor: Justin GILLAM, Oxford, MI (US)

(21) Appl. No.: 14/325,942

(22) Filed: Jul. 8, 2014

Related U.S. Application Data
(60) Provisional application No. 61/856,758, filed on Jul. 21, 2013.

(51) Int. Cl. G06F 9/48; G06F 9/50

(52) U.S. Cl. CPC G06F 9/4887; G06F 9/5088
USPC 718/104

(57) ABSTRACT

A system and method that include a task identification module configured to identify one or more tasks to be performed with respect to a vehicle. The task identification module outputs task identification data that relates to the task(s) to be performed with respect to the vehicle. A task estimation module estimates a time of completion for each of the one or more tasks. The task estimation module outputs task estimation data that relates to the time of completion for each of the task(s). The system and method may include a scheduling module to generate a vehicle task schedule based on one or both of the task identification data and the task estimation data.

### CROSS-REFERENCE TO RELATED APPLICATIONS

The application relates to and claims priority benefits from U.S. Provisional Patent Application No. 61/856,758, entitled “Scheduling Module System and Method,” filed Jul. 21, 2013, which is hereby expressly incorporated by reference in its entirety.

### BACKGROUND

1. Technical Field

Embodiments of the disclosure generally relate to systems and methods for scheduling vehicle-related tasks.

2. Discussion of Art

Vehicles may arrive and depart from a vehicle yard. The vehicles may be moved along different routes within the vehicle yard. Various processing operations may be concurrently performed on the vehicles. Due to the large amount of activity in the rail yards, it may be difficult for operators at the yards to efficiently plan for current and/or scheduled locations and operations being performed on the different vehicles.

As a vehicle arrives within the vehicle yard, various vehicle-related tasks, such as repairs, and cargo loading/unloading, may be scheduled to be performed with respect to the vehicle. One or more yard operators or employees schedule the tasks to be performed on the vehicle. One known scheduling system creates an estimated completion time for a task based on a date and time a particular vehicle is added to a work queue. However, if a particular task is delayed, the entire schedule for the particular vehicle may be disrupted. Some systems may not easily adapt to scheduling delays and changes. As such, an individual yard operator may not be provided accurate information as to when a vehicle is ready to leave the vehicle yard. It may be desirable to have systems and methods that differ from those currently available.

### BRIEF DESCRIPTION

Certain embodiments of the disclosure provide a system that may include a task identification module that identifies one or more tasks to be performed with respect to a vehicle. The task identification module may output task identification data that relates to the task(s) to be performed with respect to the vehicle. A task estimation module may estimate a time of completion for each of the task(s). The task estimation module may output task estimation data that relates to the time of completion for each of the task(s). A scheduling module may generate a vehicle task schedule based on one or both of the task identification data and the task estimation data.

A resource allocation module may allocate resources for the tasks to be performed. The resources may include one or more of employees, equipment, and facilities. In one embodiment, the resource allocation module may classify the resources based on availability and capabilities. One or both of the resource allocation module and the task estimation module may compare different resources from different suppliers, and to provide scheduling options to the scheduling module. The resource allocation module may store delivery history of the different suppliers.

The system may include a resource tracking module that can track the resources and output resource tracking data. The resource allocation module may allocate the resources based on the resource tracking data.

The system may include a task progress monitoring module that is configured to monitor progress of each of the one tasks(s) until completion. The task progress monitoring module may output task progress data that relates to the progress of each of the tasks(s). The scheduling module may update the vehicle task schedule based on the task progress data.

Embodiments of the disclosure provide a method that includes identifying one or more tasks to be performed with respect to a vehicle, outputting task identification data that relates to the tasks(s) to be performed with respect to the vehicle, estimating a time of completion for each of the task(s), outputting task estimation data that relates to the time of completion for each of the tasks(s), and generating a vehicle task schedule based on one or both of the task identification data and the task estimation data.

The method may include generating a billing invoice based at least in part on the tasks to be performed, and communicating that invoice to one or more parties interested in the performance of the tasks.

Certain embodiments of the disclosure provide a system that may include a display, and one or more processors operably connected to the display for automatically controlling the display to show an off-board user interface. The processor(s) may be configured to receive at least one first electrical signal indicative of a vehicle being within a location. The processor(s) may be configured to receive the at least one first electrical signal from at least one of an onboard system of the vehicle or a sensor located at the location. Responsive to the at least one first electrical signal, the processor(s) may be configured to identify one or more tasks to be performed with respect to a vehicle. The processor(s) may be configured to identify the tasks at least one of automatically or based on first user input of the off-board user interface or based on second user input of an on-board user interface on board the vehicle. The processor(s) may be configured to automatically output task identification data that relates to the one or more tasks to be performed with respect to the vehicle, automatically estimate a respective time of completion for each of the one or more tasks, automatically output task estimation data that relates to the time of completion for each of the one or more tasks, automatically generate a vehicle task schedule based on one or both of the task identification data and the task estimation data, and generate, at least one of automatically or based on third user input of the off-board user interface, at least one second electrical signal relating to allocating resources for the tasks to be performed.

### BRIEF DESCRIPTION OF THE DRAWINGS

The subject matter described herein may be better understood from reading the following description of non-limiting embodiments, with reference to the attached drawings, wherein below:

FIG. 1 illustrates a simplified view of a vehicle entering a vehicle yard, according to an embodiment of the disclosure.

FIG. 2 illustrates a schematic block diagram of a system for scheduling vehicle-related tasks, according to an embodiment of the disclosure.

FIG. 3 illustrates a schedule shown on a display, according to an embodiment of the disclosure.

FIG. 4 illustrates a task edit screen shown on a display, according to an embodiment of the disclosure.

FIG. 5 illustrates a production schedule report shown on a display, according to an embodiment of the disclosure.

FIG. 6 illustrates a flow chart of a method for scheduling vehicle-related tasks, according to an embodiment of the disclosure.

### DETAILED DESCRIPTION

Embodiments of the disclosure relate to systems and methods for scheduling vehicle-relates tasks. Certain embodiments of the disclosure provide systems and methods for scheduling and updating of vehicle-related tasks to be performed with respect to a vehicle within a particular location, such as a vehicle yard. The tasks may include, for example, performing maintenance, inspection, cleaning, loading/unloading of cargo, and the like. In one embodiment, a system may detect the presence of a vehicle within a location. The system may be configured to identify one or more tasks to be performed with respect to the vehicle within the location. The system may estimate the amount of time for each task to be completed, and allocate resources for each task. The system may monitor the progress of each task and update the schedule based on such monitoring.

As used herein, the term “consist” refers to a combination of two or more vehicles that are mechanically or electronically coupled with each other, so as to travel together along a route. Generally, the term consist refers to multiple powered units coupled together, but can include to a coupling of powered and unpowered units. For a consist, suitable vehicles may include propulsion-generating vehicles (vehicles capable of self-propulsion, such as locomotives, automobiles, airplanes, marine vessels, mining equipment, over the road truck and the like) and non-propulsion-generating vehicles (vehicles that are not capable of self-propulsion, such as rail cars, trailers, barges, and the like). While the description herein focuses on rail vehicles, not all embodiments are limited to rail vehicles. While the description herein may refer to the vehicle yard being a rail yard, the vehicle consists being rail vehicle consists or trains, and the vehicles being locomotives or rail cars, one or more embodiments of the systems and methods described herein also may be applied to other types of vehicles and vehicle yards. Suitable non-rail exampled may include off-highway vehicles (for example, vehicles that are not designed or permitted to travel on public roadways, such as mining equipment), automobiles, marine vessels (for example, ships through a shipyard, port, or the like), aircraft (for example, airplanes in an airport), or the like.

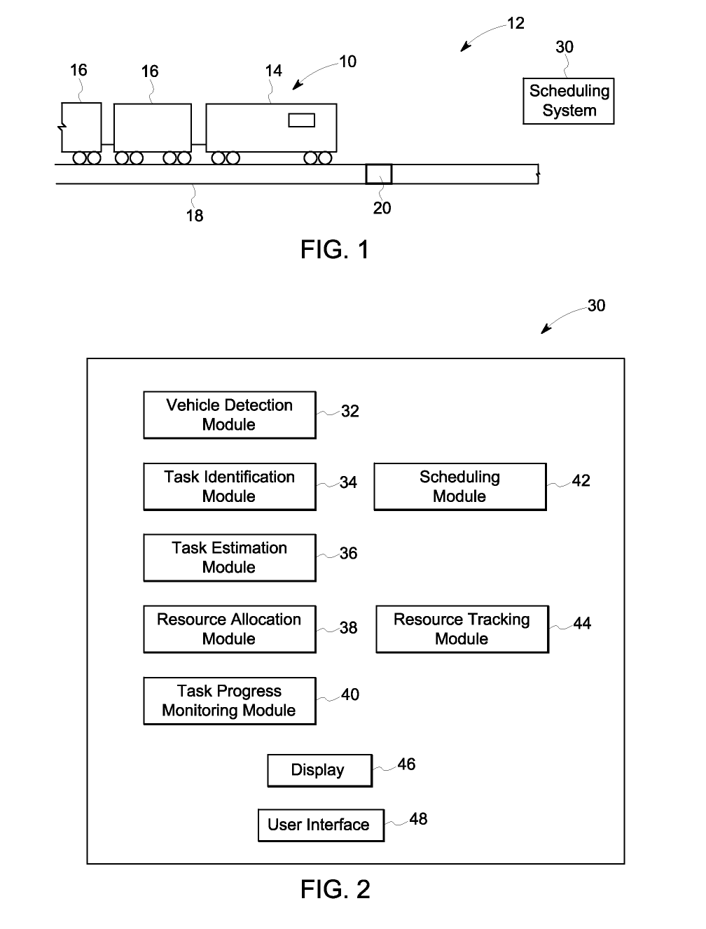

FIG. 1 illustrates a simplified view of a vehicle 10 entering a location, such as a vehicle yard 12, according to an embodiment of the disclosure. The vehicle may be or include a consist including one or more locomotives or other powered cars 14 connected to one or more unpowered cars 16 on a track 18. Alternatively, the vehicle may be or include various other types of vehicles, such as automobiles, airplanes, marine vessels, or the like.

The vehicle yard may include one or more sensors 20 configured to detect the presence of the vehicle within the vehicle yard. For example, the sensor(s) may be or include transponders, video cameras, track circuits, or the like, that detect the presence of the vehicle at one or more locations in the vehicle yard, and/or detect which operations are being performed on the vehicles. The sensor(s) and/or the vehicle may be in communication with a system 30 within the yard that schedules vehicle tasks for the vehicle. For example, as the vehicle arrives at the vehicle yard, the sensor(s) and/or the vehicle may send a signal to the system, which may then acknowledge the presence of the vehicle. The scheduling system may communicate with the vehicle to determine one or more tasks that are to be performed with respect to the vehicle. For example, the system may communicate with an onboard computer of the vehicle to determine which vehicle-related tasks are to be performed. Optionally, an operator of the vehicle may input the tasks to be performed through a user interface of the onboard computer. The input tasks may then be communicated to the system, which may then schedule the tasks to be performed.

FIG. 2 illustrates a schematic block diagram of the system for scheduling vehicle-related tasks, according to an embodiment of the disclosure. The system may include a vehicle detection module 32, a task identification module 34, a task estimation module 36, a resource allocation module 38, a task progress monitoring module 40, a scheduling module 42, a resource tracking module 44, a display 46, and a user interface 48. The system may be at a central location within the vehicle yard, for example. Optionally, the system may be remote from the vehicle yard, such as an internet website, and/or located on a particular vehicle. The system may be or include a personal computer, laptop computer, workstation, smart device, such as a handheld tablet or smart phone, and/or the like.

In operation, as a vehicle enters a location, such as the vehicle yard, the vehicle detection module may receive vehicle presence data indicating that the vehicle has entered the location. For example, one or more sensors, such as transponders, cameras, or the like, within the vehicle yard may send a signal to the vehicle detection module indicating that the vehicle has entered the location. Optionally, as a vehicle enters the location, an operator onboard the vehicle may send a signal indicating the presence of the vehicle within the location. The vehicle-related tasks may include, for example, performing maintenance, inspection, cleaning, loading/unloading of cargo, and the like.

As the presence of the vehicle is detected, the system may initiate scheduling of vehicle-related tasks. For example, upon detection of the vehicle, such as an automatic detection by the vehicle detection module, the system may begin to analyze the detected vehicle to determine which tasks are to be performed, which resources are to be allocated to perform the tasks, and scheduling of the tasks.

The system may receive the vehicle presence data and add the vehicle to a schedule. For example, based on the vehicle presence data received by the vehicle detection module, the scheduling module may add the particular vehicle to a schedule. As described below, the system may add tasks to be performed with respect to the vehicle to time slots, assign or allocate resources (including employees, equipment, facilities, devices, components, parts, and the like) with respect to the tasks, display information about the task progress, transaction, and/or the like, and close out the tasks upon completion.

Upon addition of a vehicle to a schedule, the scheduling module may generate or otherwise add scheduling data to the schedule. The scheduling data may be or include, for example, task start date and time, projected completion date and time, estimated release date and time, and the like. Such data may be used with respect to a production schedule report for the vehicle.

After the vehicle detection module detects the presence of the vehicle within the location, the task identification module may identify one or more tasks to be performed with respect to the vehicle. For example, the task identification module may interrogate one or more sensors, computers (such as a memory, database, etc.) or the like of the vehicle to determine which tasks are to be performed. Optionally, an operator onboard the vehicle may communicate with the task identification module (such as through inputting data through a user interface of a computer) to identify the tasks to be performed with respect to the vehicle. The task identification module may output task identification data to the task estimation module and/or the scheduling module.

After the task identification module identifies the tasks that are to be performed with respect to the vehicle, the task estimation module may estimate the time and resources needed to complete each task. For example, the task estimation module may include or be in communication with a memory, database, or the like that stores data related to times and resources for various tasks. The stored data may be based on actual tasks previously performed, for example. The task estimation module may output task estimation data to the scheduling module and/or the resource allocation module. The task estimation module, which may include stored data related to the estimated time and resources for each task to be performed, may be shown on the display. Alternatively, the system may not include the task estimation module, but may, instead, identify the tasks to be performed through the task identification module, and then proceed to allocate the resources for such tasks.

The task estimation data may be or include scheduled times for tasks based on various input values. For example, when the task relates to a repair of a vehicle, the task estimation data may include scheduled hours for the repair. The task estimation data may include estimated times that may be incorporated into the schedule generated by the scheduling module as default values.

The scheduling module may schedule the tasks to be performed with respect to the vehicle based on the identified tasks to be performed by the task identification module and the estimated time for completion of each task determined by the task estimation module. As an example, the task identification module may identify first and second tasks to be performed, while the task estimation module may estimate that the first task will take an hour to complete and the second task will take 3 days to complete. The scheduling module may generate an initial schedule based on the received task identification data and the task estimation data.

The initial schedule may indicate task completion dates and/or times that may be automatically calculated. Optionally, the task completion dates and/or times may be updated in response to triggering events, such as included within resource tracking data output by the resource tracking module.

An individual may view the initial schedule on the display. The individual may utilize the user interface to navigate the displayed schedule, which may list the tasks to be performed with the scheduled and estimated times for the tasks. The user may input update data through the user interface to update the scheduled times, such as scheduled times of repairs. The individual may modify the schedule of tasks from default estimated times to values defined by the individual. For example, the individual may modify the schedule of tasks if the total scheduled time for the tasks exceeds: a desired departure date of the vehicle, available time for employee(s) to perform the task(s), or the like.

Based on the identified tasks to be performed, the resource allocation module allocates or otherwise assigns resources for each task. For example, the resource allocation module may include or be in communication with a memory, database, or the like that stores data related to resources to be used for each task. The stored data may be based on actual tasks previously performed, for example. As an example, for a repair task, the resource allocation module may determine that one or more yard workers and one or more parts are needed to complete the particular repair task. The resource allocation module may determine the available resources (including yard workers, equipment, facilities, parts, components, and the like), allocate or assign such resources to the particular task, and output such information to the scheduling module as resource allocation data. Based on the allocated resources, the task estimation module may update the estimated time for task completion.

The resource allocation module may assign employees with available-to-schedule hours to tasks, such as repair transactions. The resource allocation module may further assign resources, such as equipment, areas within the vehicle yard, and the like, for each task. Optionally, an individual may input resource data through the user interface. For example, the individual may assign employees (who may be identified in a labor tracking system, which may be part of the resource tracking system) to each task and assign a scheduled time for each employee to perform a task. The scheduled time may be limited by a threshold value, such as the maximum number of hours an employee may be scheduled to work within a given time period, such as a day, week, month, or the like. As one example, the total scheduled time for an employee may equal the total scheduled time for the task to be performed on the vehicle.

The resource allocation module may allocate resources for the tasks to be performed in response to one or more of the task identification data or the task estimation data. For example, the resource allocation may allocate resources through the use of a lookup table, a database, and the like. The allocation may be static, or dynamic. In one embodiment, an operator may access the resource allocation module to manually configure resource allocation.

The scheduling module may update the initial schedule based on the resource allocation data output by the resource allocation module. For example, the initial schedule may be generated based on presumptions and/or initial determinations of available resources at a particular time. However, the resources may not be available at such times, and the scheduling module may update the generated schedule based on the actual availability of the resources. In this manner, the resource allocation module and/or the scheduling module may be in communication with the resource tracking module, which tracks the availability of the resources within the vehicle yard. For example, available resources may include one or more sensors that indicate whether they are in use or not. Optionally, yard workers may transmit data to the resource tracking module, such as through handheld devices, indicating their availability and/or the availability of particular equipment, facilities, devices, components, parts, and/or the like within the vehicle yard.

After the resource allocation module 38 has allocated the resources for a particular task, the task progress monitoring module 40 may monitor the progress of the task. For example, yard workers may carry a handheld device through which they may indicate the progress or completion of a particular task. Progress data input through the handheld device may be received by the task progress monitoring module 40, which may update the progress of the task based on the received data. Optionally, the vehicle may communicate with the task progress monitoring module to provide task update data. For example, if a task includes vehicle refueling, an onboard computer of the vehicle that monitors fuel levels may communicate with the task progress monitoring module to indicate the fuel level of the vehicle. As another example, if a task includes the vehicle being weighed, a scale within the vehicle yard may communicate with the task progress monitoring module to indicate the progress of weighing the vehicle. As another example, if a task includes loading cargo onto the vehicle, the cargo may include a tracking device, such as a radio frequency identification tag, that may be tracked by the task progress monitoring module 40, which may determine that the cargo has been loaded onto the vehicle.

The task progress monitoring module may output task progress data to the scheduling module. The scheduling module may receive the task progress data and update the vehicle schedule accordingly.

An individual may indicate completion of actual time of effort for employees assigned to each task. For example, the task progress data may be data input by an individual that indicates the actual time an employee worked to complete a particular task. The work time may be input electronically and uploaded to the schedule in real time or near-real time. For example, a time clock link may be in communication with the resource tracking module, which may include a labor tracking module. Entry of data into the time clock link may update the task progress data, for example. Upon completion, the actual time worked by each employee on a task may be recorded in conjunction with the scheduled time for the task.

In one embodiment, the actual time worked by an employee with respect to a task may be input into the resource tracking module and/or the scheduling module. Alternatively, the scheduling module may access labor data from a separate database.

The scheduling module may show the schedule on the display. The display may be or include a computer monitor, television screen, plasma screen, LED screen, LCD screen, projector, touchscreen interface of a handheld device, and/or the like. The system may also include a user interface 48 (such as a keyboard, mouse, touchscreen interface, buttons, and/or the like) that allows an individual to interact with the displayed schedule. Alternatively, the system may not include the display and the user interface. Instead, the system may be in communication with computers or the like at remote locations that may show the schedule.

A schedule report for the vehicle may be shown on the display. In one embodiment, the production schedule report may be printed for a particular task. The schedule report may show the scheduled times, assigned resources, such as employees, dedicated assets and locations, for each task.

In one embodiment, a repair task for a vehicle may be initiated by generating a repair start date, a projected completion date, and an estimated release date. If the repair task is approved and workable, the scheduled time for the repair may be identified as available and booked for that repair. The vehicle status may then be marked as approved for the repair task in the schedule.

When an additional or supplemental repair task is to be added to a vehicle that already has a repair task scheduled (such as in response to an inspection), the system may identify and set aside the supplemental repair task. When adding a repair task that has not yet been performed, an inspection box shown on the display may be unchecked and the estimate/work order status may be bypassed. For example, if the initial repair task has yet to be performed, the supplemental repair task may be not added to the schedule until the first repair task is completed.

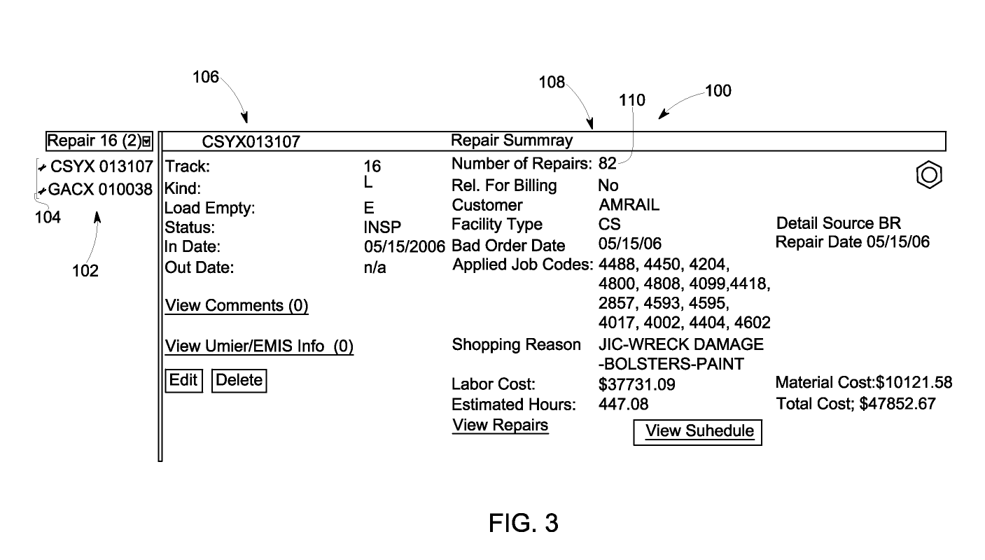

FIG. 3 illustrates a schedule 100 shown on a display, such as the display 46, according to an embodiment of the disclosure. The schedule includes a vehicle selection area 102 that may list one or more vehicles 104 that an individual may select for scheduling. The schedule may also include a logistical section 106 that may lists the location of the vehicle within the vehicle yard, the kind of vehicle, the cargo status of the vehicle (for example, loaded, partially loaded, or empty), the status of the vehicle (as shown in FIG. 3, the vehicle is being inspected), the date the vehicle entered the vehicle yard, the date the vehicle departed the yard, and the like. The schedule may also include a task summary section 108, which may list the number of tasks to be performed (as shown in FIG. 3, eighty-two repair tasks are to be performed), the customer, the facility type, the order date, applied job codes, shopping reason, projected labor costs, estimated hours for the tasks, material costs, and total costs.

The displayed schedule may be used by an individual to modify the scheduled and actual times for the tasks, such as the repairs. The schedule may be accessed through a repair schedule link of a repair panel portion of a view vehicle screen, for example. The view repair schedule screen may be accessed by clicking on the number of repairs 110, for example, and may list all of the repairs for the vehicle. For each listed report, a checkbox may be displayed next to repair information, and scheduled, estimated, and completion times for each repair. The status for each repair, such as approved, not approved, completed, may also be listed.

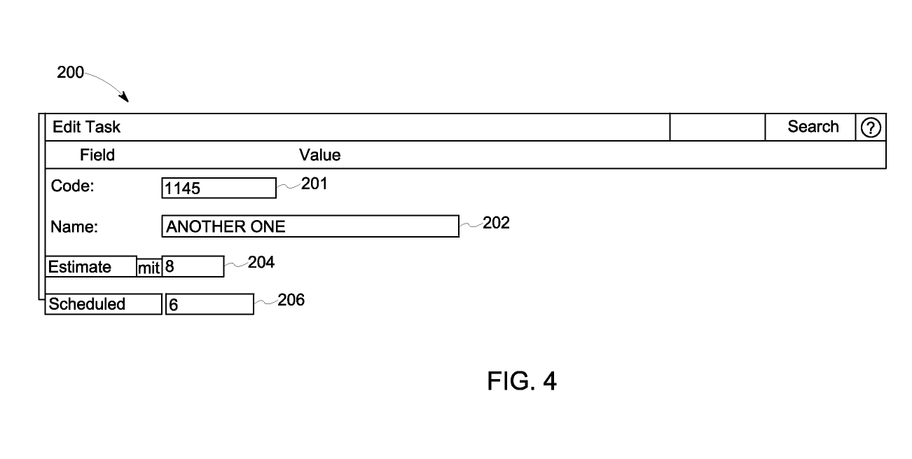

FIG. 4 illustrates a task edit screen 200 shown on a display, such as the display 46, according to an embodiment of the disclosure. Tasks, such as repairs, may be edited by an individual. For example, an individual may edit the estimated times for tasks. As an example, the task edit screen may include a task code 201 and a name of a task 202 that an individual may click on or toggle through, for example. The individual may select the task and input data through a task estimate field 204 and/or a scheduled task field 206 to change the estimated time and scheduled time for a task.

The task edit screen may be used to update or change default settings of a generated schedule, for example. As an example, the task edit screen may allow an individual to change information on the schedule through checkboxes, clicking on edit buttons, and/or the like.

An individual may assign employees with respect to one or more tasks for a vehicle. For example, the individual may check a box next to an approved repair and click on an employee-assignment feature, such as a button, toggle, link, or the like. The display may then show a labor hours entry screen for the individual to schedule and assign the employee.

Clicking on an add button may expand an entry area at the bottom of the grid. An individual may select an employee and enter a number of scheduled hours for that employee for a particular task, such as a repair. The system may verify that the scheduled hours match the total of the scheduled hours of the employee(s). If there is no match, the system may prohibit such entry, or may accept the information and generate a warning flag.

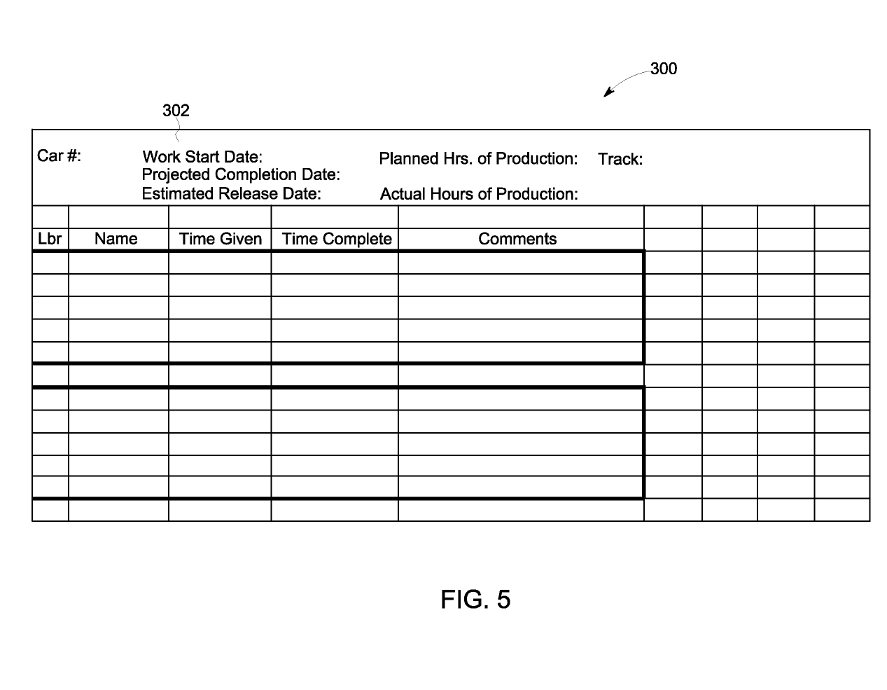

FIG. 5 illustrates a production schedule report 300 shown on a display, such as the display 46, according to an embodiment of the disclosure. The scheduling module may generate the production schedule report.

The production schedule report may include header fields 302 that may include Work Start Date, Project Completion Date and Estimated Release Date. These fields may be filled by an individual, for example. Planned hours or production may arise from scheduled hours total on a task, and/or from employee assignment records.

In one embodiment, the resource allocation module may be configured to assign tasks to employees based on capabilities of the employees. For example, the resource allocation module may categorize employees based on skills used to perform certain tasks (for example, welding, heavy machinery operation, and the like), skill levels and experience, certificates of achievement, and the like. For example, the validity of certification may be indexed by the resource allocation module with respect to renewal dates and reminders. Further, the resource allocation module may create one or more capability groups, which may tie specific skills to task codes, thereby allowing the resource allocation module to quickly identify and assign such employees to tasks that they are well-suited to perform. For example, the resource allocation module may list one or more employees that are trained for underwater welding using an acetylene torch that may be well-suited for a particular task. The resource allocation module may show a list of employees well-suited for a particular task on the display. An individual may enter key words, codes, or the like for a particular task (such as “underwater,” “welding,” and “acetylene”) through the user interface, and the resource allocation module may output a list of employees that are ranked based on the search. For example, an employee with all three attributes may be rated near the top of the list (such as over another employee with all three attributes but less experience in one or more of the categories).

The resource allocation module may classify employees based on employment status, hourly rate, geographic location, current work load, skill type, skill level, prior work history, and the like. Additionally, the resource allocation module 38 may evaluate employee scheduling in relation to contractor scheduling, with a weighted preference to one relative to the other.

Additionally, the resource allocation module may track and index availability, capability, status, location, and the like of resources, such as tools and equipment, that are configured to be used with respect to certain tasks, such as repairs and maintenance.

In one embodiment, the system may generate and update a vehicle task schedule in relation to a needed parts inventory. For example, the resource allocation module and/or the task estimation module may determine when a task can be completed based at least in part on inventory availability, location, and delivery time. The module(s) may also generate a schedule based at least in part on part quality data. For example, the module(s) may compare an estimated time of task completion depending on resource type used, such as parts, devices, equipment, components or the like from a vendor with a first lead time at a first geographic distance plus travel/delivery time (for example, time of travel on boat versus plane or truck) and from another vendor with a second lead time at a second geographic location plus a different travel/delivery time, as well as associated cost factors. The task estimation module 36 and the resource allocation module may be used to compare different resources from different suppliers, manufacturers, vendors, or the like to provide options to be used by the scheduling module to generate numerous scheduling options.

Optionally, the module(s) may compare promised delivery date with received date to analyze the delivery history for various suppliers, vendors, and the like. For example, the task estimation module may store supplier delivery history in a memory or database. The task estimation module may calculate estimated task completion based, at least in part, on delivery history data, for example.

The system may use a delivery history of multiple suppliers to select one the suppliers. The system may contact the selected supplier to supply resources, or to select particular resources from an inventory for the selected supplier.

The scheduling module may be weighted or biased in relation to certain preferred customers, for example. As an example, the resource allocation module may prioritize resource allocation based on a preferred or weighted status of a particular vehicle or customer. Other determined weightings may reflect shop efficiencies, worker efficiency, and parts cost, quality, and availability (as well as the availability of workers, equipment, etc. at each shop). Each step in the task process may have a corresponding time or efficiency value associated therewith. By displaying time/efficiency values, in raw or normalized form, the system may identify bottlenecks. For example, the system may highlight processes, equipment availability, and/or employees that may be causes of delay.

Each of the modules 32, 34, 36, 38, 40, 42, and 44 may be or include one or more control units, circuits, or the like, such as processing devices that may include one or more microprocessors, microcontrollers, integrated circuits, memory, such as read-only and/or random access memory, and the like. As an example, each of the modules may include or be formed as an integrated chip. Each of the modules may be separate and distinct circuits or processors within the system, for example. Optionally, the modules may be integrated into a single circuit or processor. Optionally, the modules may be separate and distinct modules that are in communication with one another through wired or wireless connections. The modules may be contained within a workstation that may be or otherwise include one or more computing devices, such as standard computer hardware (for example, processors, circuitry, memory, and the like).

The system may include any suitable computer-readable media used for data storage. For example, the modules may include computer-readable media. The computer-readable media are configured to store information that may be interpreted by the modules. The information may be data or may take the form of computer-executable instructions, such as software applications, that cause a microprocessor or other such control unit within the modules to perform certain functions and/or computer-implemented methods. The computer-readable media may include computer storage media and communication media. The computer storage media may include volatile and non-volatile media, removable and non-removable media implemented in any method or technology for storage of information such as computer-readable instructions, data structures, program modules or other data. The computer storage media may include, but are not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which may be used to store desired information and that may be accessed by components of the system.

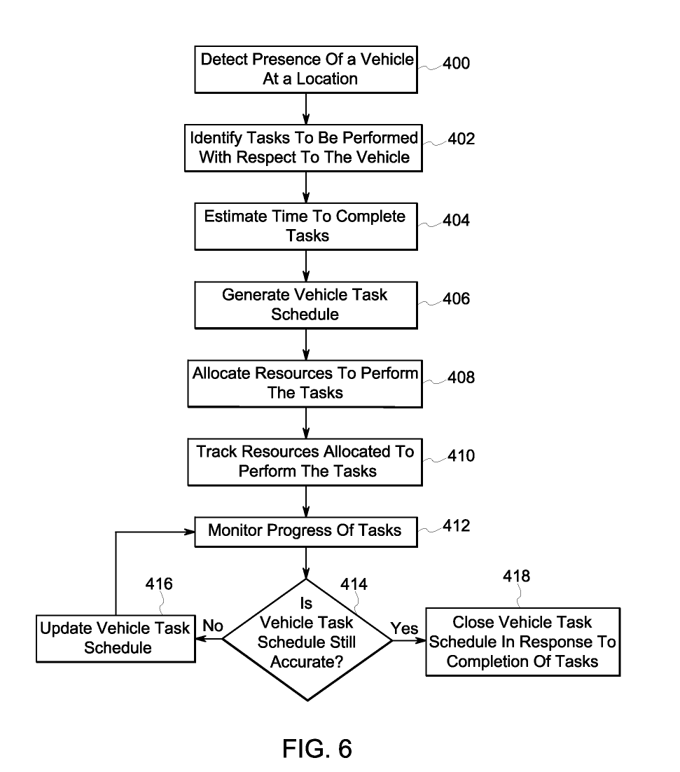

FIG. 6 illustrates a flow chart of a method for scheduling vehicle-related tasks, according to an embodiment of the disclosure. At 400, a presence of a vehicle, such as a consist, is detected at a location, such as a vehicle yard. In one embodiment, the presence of the vehicle may be detected through one or more sensors at certain area(s) within the location. Alternatively, an operator of the vehicle may send a signal to the scheduling system that indicates the presence of the vehicle within the location.

At 402, tasks to be performed with respect to the vehicle are identified. In one embodiment, the scheduling system, such as through a task identification module, may analyze received task identification data from the vehicle, which may be input by a user or automatically generated based on data stored within the vehicle. The scheduling system may utilize the task identification data to form a vehicle task schedule.

At 404, the time to complete the tasks is estimated. The scheduling system, such as through a scheduling module, may receive task estimation data and the task identification data, to generate the vehicle task schedule at 406.

After the task schedule is generated, resources are allocated to perform the tasks at 408. For example, a resource allocation module may automatically allocate resources for the tasks to be performed. Optionally, an individual may be prompted to pick and choose resources to allocate for the tasks. At 410, the allocated resources are tracked with respect to the tasks. Then, at 412, the progress of the tasks is monitored. At 414, it is determined whether the vehicle task schedule is still accurate, based on received task progress data. If not, the process continues to 416, in which the vehicle task schedule is updated, and then the process returns to 412. If, however, the vehicle task schedule is still accurate, then the process continues to 418, in which the vehicle task schedule is closed when the tasks are completed.

The method may include generating a billing invoice based at least in part on the tasks to be performed, and communicating that invoice to one or more parties interested in the performance of the tasks. (The one or more parties may be designated to receive information, e.g., the billing invoice(s), about the tasks to be performed.) For example, the system may include a billing module that generates an invoice based on the scheduled tasks to be performed. The billing module, a communication module, or another module may communicate the invoice, such as through electronic mail, regular mail, and the like, to one or more parties that are interested in the performance of the tasks.

As described above, embodiments of the disclosure provide systems and methods for scheduling vehicle-related tasks to be performed with respect to vehicles in a location, such as a vehicle yard. The systems and methods may include receiving task identification data to determine a schedule for the tasks. The task identification data may be automatically generated or received through user input, for example.

As described above, certain embodiments of the disclosure provide a system that may include a task identification module configured to identify one or more tasks to be performed with respect to a vehicle. The task identification module may be further configured to output task identification data that relates to the task(s) to be performed with respect to the vehicle. The system may also include a task estimation module configured to estimate a time of completion for each of the task(s). The task estimation module may be further configured to output task estimation data that relates to the time of completion for each of the task(s). The system may also include a scheduling module configured to generate a vehicle task schedule based on one or both of the task identification data and the task estimation data.

In one embodiment, the system may include a resource allocation module that is configured to allocate resources for the tasks to be performed. The resources may include one or more of employees, equipment, and facilities. The resource allocation module may be configured to classify the resources based on availability and capabilities. One or both of the resource allocation module and the task estimation module may be configured to compare different resources from different suppliers, and to provide scheduling options to the scheduling module. The resource allocation module may also be configured to store delivery history of the different suppliers. The comparison between the different suppliers may include cost, timing, and/or quality comparisons, for example.

The system may include a resource tracking module that is configured to track the resources and output resource tracking data. The resource allocation module may allocate the resources based on the resource tracking data.

The system may include a task progress monitoring module that is configured to monitor progress of each of the task(s) until completion. The task progress monitoring module may output task progress data that relates to the progress of each of the task(s). The scheduling module may update the vehicle task schedule based on the task progress data.

The system may also include a vehicle detection module configured to detect a presence of the vehicle within a location. In one embodiment, the vehicle detection module is configured to receive vehicle presence data through one or more sensors within the location.

In one embodiment, the vehicle may include a train including at least one powered car and at least one unpowered car. Alternatively, the vehicle may be various other types.

Certain embodiments of the disclosure provide a method that may include identifying one or more tasks to be performed with respect to a vehicle, outputting task identification data that relates to the tasks(s) to be performed with respect to the vehicle, estimating a time of completion for each of the task(s), outputting task estimation data that relates to the time of completion for each of the tasks(s), and generating a vehicle task schedule based on one or both of the task identification data and the task estimation data.

The method may include using a resource allocation module to allocate resources for the tasks to be performed. The resources may include one or more of employees, equipment, and facilities. The method may also include using the resource allocation module to classify the resources based on availability and capabilities. The method may include comparing different resources from different suppliers, and providing scheduling options based on the comparing operation. The method may also include storing delivery history of the different suppliers. In one embodiment, the method may also include tracking the resources, outputting resource tracking data that relates to the resources that are tracked, and allocating the resources based on the resource tracking data. The method may also include monitoring progress of each of the task(s) until completion, outputting task progress data that relates to the progress of each of the task(s), and updating the vehicle task schedule based on the task progress data. In one embodiment, the method may also include automatically detecting a presence of the vehicle within a location.

Certain embodiments of the disclosure provide a system that may include a display, and one or more processors operably connected to the display for automatically controlling the display to show an off-board user interface. (That is, the display, and consequently the user interface shown on the display, is located off-board a vehicle.) The processor(s) may be configured to receive at least one first electrical signal indicative of a vehicle being within a location. The processor(s) may be configured to receive the at least one first electrical signal from at least one of an onboard system of the vehicle or a sensor located at the location. Responsive to the at least one first electrical signal, the processor(s) may be configured to identify one or more tasks to be performed with respect to a vehicle. The processor(s) may be configured to identify the tasks at least one of automatically or based on first user input of the off-board user interface or based on second user input of an on-board user interface on board the vehicle. The processor(s) may be configured to automatically output task identification data that relates to the one or more tasks to be performed with respect to the vehicle, automatically estimate a respective time of completion for each of the one or more tasks, automatically output task estimation data that relates to the time of completion for each of the one or more tasks, automatically generate a vehicle task schedule based on one or both of the task identification data and the task estimation data, and generate, at least one of automatically or based on third user input of the off-board user interface, at least one second electrical signal relating to allocating resources for the tasks to be performed.

Any of the modules set forth herein may be configured to implement one or more of the steps or functions as set forth herein automatically, meaning at least partially without human control.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

The above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended clauses, along with the full scope of equivalents to which such clauses are entitled. In the appended clauses, the terms “including” and “in which” are used as the plain-English equivalents of the respective terms “comprising” and “wherein.” Moreover, in the following clauses, the terms “first,” “second,” and “third,” etc. are used merely as labels, and are not intended to impose numerical requirements on their objects. Further, the limitations of the following clauses are not written in means-plus-function format and are not intended to be interpreted based on 35 U.S.C. §112(f), unless and until such clause limitations expressly use the phrase “means for” followed by a statement of function void of further structure.

This written description uses examples to disclose several embodiments of the inventive subject matter and also to enable a person of ordinary skill in the art to practice the embodiments of the inventive subject matter, including making and using any devices or systems and performing any incorporated methods. The patentable scope of the inventive subject matter is defined by the clauses, and may include other examples that occur to those of ordinary skill in the art. Such other examples are intended to be within the scope of the clauses if they have structural elements that do not differ from the literal language of the clauses, or if they include equivalent structural elements with insubstantial differences from the literal languages of the clauses.

1. A system comprising:
a task identification module configured to identify one or more tasks to be performed with respect to a vehicle, wherein the task identification module is further configured to output task identification data that relates to the one or more tasks to be performed with respect to the vehicle;
a task estimation module configured to estimate a respective time of completion for each of the one or more tasks, wherein the task estimation module is further configured to output task estimation data that relates to the time of completion for each of the one or more tasks; and
a scheduling module configured to generate a vehicle task schedule based on one or both of the task identification data and the task estimation data.

2. The system of claim 1, further comprising a resource allocation module configured to allocate resources for the tasks to be performed in response to one or more of the task identification data or the task estimation data.

3. The system of claim 2, wherein the resources include one or more of employees, equipment, or facilities.

4. The system of claim 2, wherein the resource allocation module is configured to classify the resources based on availability and capabilities.

5. The system of claim 2, wherein one or both of the resource allocation module and the task estimation module is configured to compare resources supplied from two or more different suppliers, and to provide scheduling options to the scheduling module.

6. The system of claim 5, wherein the resource allocation module is configured to store delivery history of the different suppliers.

7. The system of claim 2, further comprising a resource tracking module configured to track the resources and output resource tracking data, and wherein the resource allocation module is further configured to allocate the resources based on the resource tracking data.

8. The system of claim 1, further comprising a task progress monitoring module configured to monitor progress of each of the one or more tasks until completion, wherein the task progress monitoring module is further configured to output task progress data that relates to the progress of each of the one or more tasks, and wherein the scheduling module is further configured to update the vehicle task schedule based on the task progress data.

9. The system of claim 1, further comprising a vehicle detection module configured to detect a presence of the vehicle within a location, wherein the task identification module is configured to identify one or more tasks to be performed with respect to the vehicle in response to the vehicle detection module detecting the presence of the vehicle.

10. The system of claim 9, wherein the vehicle detection module is configured to receive vehicle presence data through one or more sensors within the location.

11. The system of claim 1, wherein the vehicle comprises a locomotive or mining equipment.

12. A method comprising:
outputting task identification data that relates to one or more tasks to be performed with respect to a vehicle;
estimating a respective time of completion for each of the one or more tasks;
outputting task estimation data that relates to the time of completion for each of the one or more tasks; and
generating a vehicle task schedule based on one or both of the task identification data and the task estimation data.

13. The method of claim 12, further comprising generating a billing invoice based at least in part on the tasks to be performed, and communicating the billing invoice to one or more parties designated to receive information about the performance of the tasks.

14. The method of claim 12, further comprising allocating resources for the tasks to be performed.

15. The method of claim 14, further comprising classifying the resources based on availability and capabilities.

16. The method of claim 14, further comprising:
comparing aspects of resources supplied from two or more different suppliers to form a comparison; and
providing scheduling options based on the comparison.

17. The method of claim 16, further comprising using a delivery history of the two or more suppliers to select one of the two or more suppliers.

18. The method of claim 14, further comprising:
tracking the resources;
outputting resource tracking data that relates to the resources that are tracked; and
allocating the resources based on the resource tracking data.

19. The method of claim 12, further comprising:
monitoring progress of each of the one or more tasks until completion;
outputting task progress data that relates to the progress of each of the one or more tasks; and
updating the vehicle task schedule based on the task progress data.

20. The method of claim 12, further comprising detecting a presence of the vehicle within a location, and wherein the task identification data is output in response to the presence of the vehicle being detected.

21. A system comprising:
a display; and
one or more processors operably connected to the display for automatically controlling the display to show an off-board user interface, wherein the one or more processors are configured to:
receive at least one first electrical signal indicative of a vehicle being within a location, wherein the one or more processors are configured to receive the at least one first electrical signal from at least one of an onboard system of the vehicle or a sensor located at the location;
responsive to the at least one first electrical signal, identify one or more tasks to be performed with respect to a vehicle, wherein the one or more processors are configured to identify the tasks at least one of automatically or based on first user input of the off-board user interface or based on second user input of an on-board user interface on board the vehicle;
automatically output task identification data that relates to the one or more tasks to be performed with respect to the vehicle;
automatically estimate a respective time of completion for each of the one or more tasks;
automatically output task estimation data that relates to the time of completion for each of the one or more tasks;
automatically generate a vehicle task schedule based on one or both of the task identification data and the task estimation data; and
generate, at least one of automatically or based on third user input of the off-board user interface, at least one second electrical signal relating to allocating resources for the tasks to be performed.
